(19) United States
(12) Patent Application Publication
(10) Pub. No.: US 2010/0060450 A1
(43) Pub. Date: Mar. 11, 2010

(54) HAND HELD WIRELESS 4-20mA SIGNAL TRANSMITTING AND STORAGE SYSTEM

(76) Inventor: Glenn F. Jorgensen, Ridgewood, NJ (US)

Correspondence Address: GREER, BURNS & CRAIN, 300 S WACKER DR, 25TH FLOOR, CHICAGO, IL, 60606, US

(21) Appl. No.: 12/205,958

(22) Filed: Sep. 8, 2008

(51) Int. Cl. G08B 1/08; H04B 1/00

(52) U.S. Cl. 340/539.27; 375/135; 375/E01.033

(57) ABSTRACT

A hand held wireless signal transmitting and storage system. The system includes a device configured to generate a signal to be transmitted. The system also includes a hand held wireless transmitter arranged to communicate via an electrical connection with the device to receive the signal and configured to transmit the signal. Also included in the system is a receiver configured to receive the signal from the wireless transmitter, and a data storage unit configured to connect to the receiver to receive and store the signal.

### BACKGROUND OF THE INVENTION

The present invention relates to wireless transmitters and signal storage systems, in particular, hand held wireless transmitters for 4-20 mA signals.

The present invention has a particular application to wireless transmittal of signals, such as 4-20 mA signals. These signals may relate to signals received from infrared thermometers which have utility in measuring the temperature of boilers, such as in power plants, and electrical bus bars. Although the invention is not limited to such applications, the invention will be described in such environments and uses.

Infrared thermometers are known, such as those taught in U.S. Pat. Nos. 6,102,564 and 5,368,038. Such thermometers are used in many environments including measuring the temperature of the combustion chamber in a boiler (by measuring the flue exit gases) or the temperature of a bus bar in a generator which have such high voltages and amperages that direct measurement is not feasible.

Known infrared thermometers typically have a display unit on which the temperature sensed by the thermometer is displayed so that an operator of the thermometer may view the displayed temperature and may manually record that temperature. Such manual viewing and manual recordation may lead to errors in reading or recording, and the environment in which the thermometer is located may be unsuitable for persons to stay in for extended periods of time.

### SUMMARY OF THE INVENTION

The present invention provides a hand held wireless signal transmitting and storage system. The system includes a device, for example, an infrared thermometer, configured to generate a signal to be stored and transmitted. In an infrared thermometer, the signal may be indicative of a temperature read by the thermometer. The system further includes a wireless transmitter arranged to communicate via an electrical connection with the device to receive the signal and configured to transmit the signal, which may be a 4-20 mA signal. Also included is a receiver configured to receive the signal from the wireless transmitter and a data storage unit configured to connect to the receiver to receive and store the signal.

In an embodiment, the wireless transmitter is a frequency hopping spread spectrum transmitter.

In an embodiment, the wireless transmitter includes a display unit arranged to display an indicia indicative of a signal generated by the device.

In an embodiment, the transmitter is battery powered.

In an embodiment, the electrical connection comprises a wired connection extending between the thermometer and the transmitter.

In an embodiment, the receiver is frequency synced to the transmitter to receive the signal from the wireless transmitter.

In an embodiment, the receiver includes a display unit arranged to display an indicia indicative of the signal generated by the device.

In an embodiment, the receiver is battery powered.

In an embodiment, the data storage unit comprises a flash memory drive.

In an embodiment, the data storage unit comprises a connector permitting a removable connection between the data storage unit and the receiver, and between the data storage unit and a personal computer.

In an embodiment, the data storage unit comprises a USB connector.

In an embodiment, the device is an infrared thermometer.

### BRIEF DESCRIPTION OF THE DRAWING

FIG. 1 is a perspective view of a hand held wireless signal transmitting and storage system.

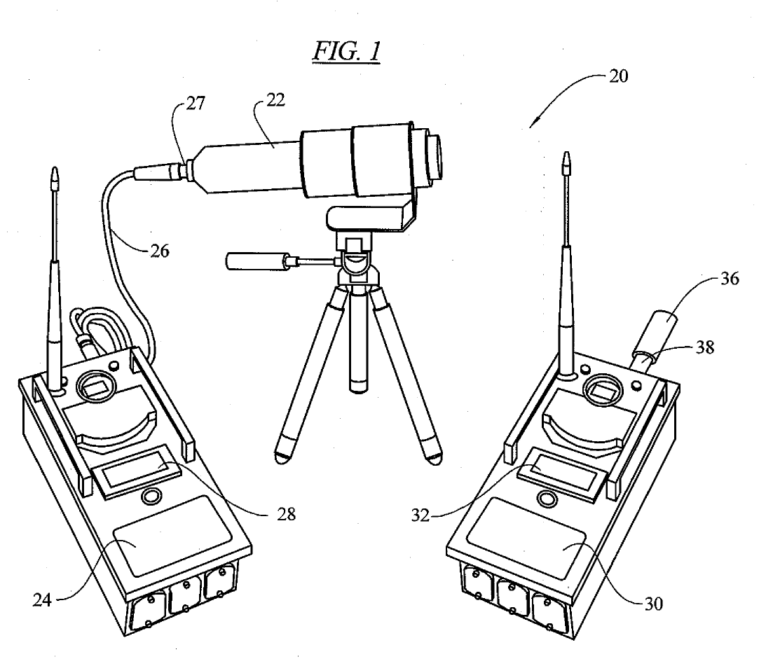

FIG. 2 is a schematic electrical diagram of a transmitter portion of the system of FIG. 1.

FIG. 3 is a schematic electrical diagram of a receiver portion of the system of FIG. 1.

### DETAILED DESCRIPTION OF THE PREFERRED EMBODIMENTS

As illustrated in the Figures, the present invention provides a wireless hand held signal transmitting and storage system 20. The system includes a device 22, such as an infrared thermometer, configured to generate a signal to be transmitted. With respect to an infrared thermometer, the signal may be indicative of a temperature read by the thermometer.

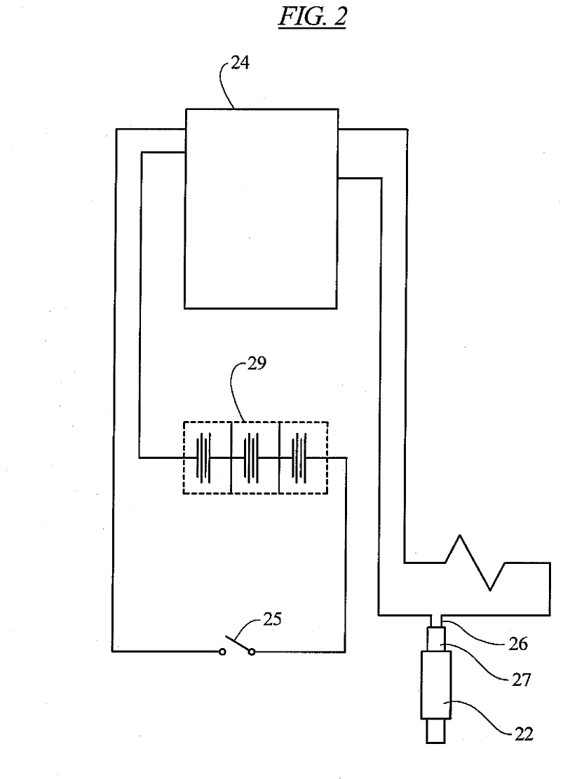

A hand held wireless transmitter 24 (FIG. 2) operated with an on-off switch 35 is arranged to communicate via an electrical connection 26 with the device 22 to receive the signal and configured to transmit the signal.

The electrical connection 26, in an embodiment, may be a wired connection between the device 22 and the transmitter 24. Suitable connectors 27 are provided at the device 22 and at the transmitter 24, such as coaxial connectors to receive a coaxial cable connection between the two components.

The transmitter 24 may include a display unit 28 arranged to display an indicia indicative of the signal being sent by the device 22, such as a temperature read in the case where the device is a thermometer. In an embodiment, the display unit 28 may be an LCD or an LED capable of displaying a temperature in the range expected to be read by the thermometer 22. For example, when reading the temperature of bus bars, the expected temperatures fall in the range of 0 degrees F. (−18 degrees C.) and 1000 degrees F. (538 degrees C.). In a boiler arrangement, the expected temperature may fall in the range of 250 degrees F. (121 degrees C.) and 3000 degrees F. (1649 degrees C.). The transmitter 24 may also be able to convert and display the temperature read by the thermometer into either Fahrenheit or Centigrade scales.

The transmitter 24 may be a frequency hopping spread spectrum transmitter. For example, the transmitter 24 may be a 900 MHz transmitter that may transmit a 4-20 mA signal with a range up to ⅝ miles (1 Km). The transmitter 24 may be powered by batteries 29 so that the device 22 and transmitter may be used in locations that have limited or no ac power supplies. The batteries 29 should have a relatively long operating life, such as at least 12 hours when using alkaline batteries and 32 hours when using lithium batteries.

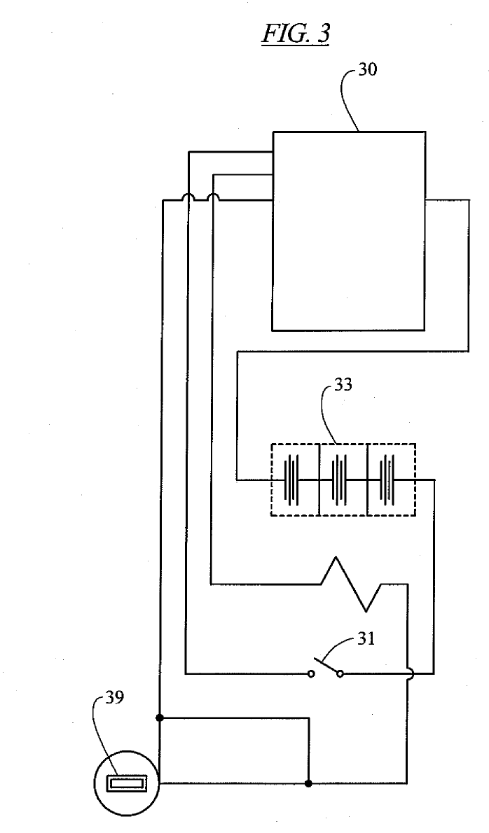

A receiver 30 (FIG. 3) operated with an on-off switch 31 is provided for receiving the signal from the wireless transmitter 24. The receiver 30 may be frequency synced to the transmitter 24 to properly receive the transmitted signal from the transmitter when the transmitter is frequency hopping.

The receiver 30 may include a display unit 32 arranged to display an indicia indicative of the signal transmitted by the device 22. In an embodiment, the display unit 32 may be an LCD or an LED capable of displaying a temperature in the range expected to be read by the thermometer 22. For example, when reading the temperature of bus bars, the expected temperatures fall in the range of 0 degrees F. (−18 degrees C.) and 1000 degrees F. (538 degrees C.). In a boiler arrangement, the expected temperature may fall in the range of 250 degrees F. (121 degrees C.) and 3000 degrees F. (1649 degrees C.). The receiver 30 may also be able to convert and display the temperature read by the thermometer into either Fahrenheit or Centigrade scales.

The receiver 24 may be powered by batteries 33 so it may be used in locations that have limited or no ac power supplies. The batteries should have a relatively long operating life, such as at least 12 hours when using alkaline batteries and 32 hours when using lithium batteries.

A data storage unit 36 may be provided which is configured to connect to the receiver 30 to receive and store the signal received at the receiver. In an embodiment, the data storage unit 36 comprises a flash memory drive. The data storage unit may also comprise other types of electronic or magnet memory, such as hard disks, CDs, DVDs, floppy disks, RAM or ROM memory, EPROM devices, magnetic tape and other types of memory storage units. The data storage unit 36 may also comprise a connector 38 permitting a removable connection between the data storage unit and a connector 39 at the receiver 24, so that the data storage unit may be a portable unit separable from the receiver. This connector 38 may also be used to provide a connection between the data storage unit 36 and a computer, such as a personal computer. In this manner, multiple temperature readings may be stored in the data storage unit 36 as the temperatures are read by the thermometer 22, and later transferred to or used by a computer and imported into a software program such as Excel for further use. The connector may be a USB connector, or other type of connector typically used for providing data inputs into computers.

The data storage unit 36 may be programmed to store the readings at selected times by connecting the data storage unit to a computer and setting up the procedure in which readings are stored at the selected intervals. The data storage unit 36 should be capable of storing a large number of readings, for example more than 30,000 readings. These readings may be provided by the thermometer 22 and recorded in the data storage unit 36 at intervals selected by the user in the range between one each second and one each 12 hours. The data storage unit 36 may have its own power supply, such as a battery, or may be powered by the device it is connected to, such as the receiver 30 or the computer.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

I claim as my invention:

1. A hand held wireless signal transmitting and storage system comprising:
a device configured to generate a signal to be transmitted,
a hand held wireless transmitter arranged to communicate via an electrical connection with said device to receive said signal and configured to transmit said signal,
a receiver configured to receive said signal from said wireless transmitter, and
a data storage unit configured to connect to said receiver to receive and store said signal.

2. The hand held wireless signal transmitting and storage system according to claim 1, wherein said wireless transmitter is a frequency hopping spread spectrum transmitter.

3. The hand held wireless signal transmitting and storage system according to claim 1, wherein said wireless transmitter includes a display unit arranged to display an indicia indicative of the signal generated by said device.

4. The hand held wireless signal transmitting and storage system according to claim 1, wherein said transmitter is battery powered.

5. The hand held wireless signal transmitting and storage system according to claim 1, wherein said electrical connection comprises a wired connection extending between said device and said transmitter.

6. The hand held wireless signal transmitting and storage system according to claim 1, wherein said receiver includes a display unit arranged to display an indicia indicative of the signal generated by said device.

7. The hand held wireless signal transmitting and storage system according to claim 1, wherein said receiver is battery powered.

8. The hand held wireless signal transmitting and storage system according to claim 1, wherein said data storage unit comprises a flash memory drive.

9. The hand held wireless signal transmitting and storage system according to claim 1, wherein said data storage unit comprises a connector permitting a removable connection between said data storage unit and said receiver, and between said data storage unit and a personal computer.

10. The hand held wireless signal transmitting and storage system according to claim 9, wherein said data storage unit comprises a USB connector.

11. The hand held wireless signal transmitting and storage system according to claim 1, wherein said device is an infrared thermometer.

12. A hand held wireless signal transmitting and storage system comprising:
a device configured to generate a signal to be transmitted,
a hand held wireless transmitter comprising a frequency hopping spread spectrum transmitter arranged to communicate via an electrical connection with said device to receive said signal and configured to transmit said signal,
a receiver frequency synced to said transmitter to receive said signal from said wireless transmitter,
a data storage unit configured to connect to said receiver to receive and store said signal.

13. The hand held wireless signal transmitting and storage system according to claim 12, wherein one of said wireless transmitter and said receiver includes a display unit arranged to display an indicia indicative of the signal generated by said device.

14. The hand held wireless signal transmitting and storage system according to claim 12, wherein one of said transmitter and said receiver is battery powered.

15. The hand held wireless signal transmitting and storage system according to claim 12, wherein said electrical connection comprises a wired connection extending between said device and said transmitter.

16. The hand held wireless signal transmitting and storage system according to claim 12, wherein said data storage unit comprises a connector permitting a removable connection between said data storage unit and said receiver, and between said data storage unit and a personal computer.

17. The hand held wireless signal transmitting and storage system according to claim 12, wherein said device comprises an infrared thermometer.

18. A temperature sensing, signal transmitting and storage system comprising:
an infrared thermometer configured to generate a signal indicative of a temperature read by said thermometer,
a wireless transmitter comprising a frequency hopping spread spectrum transmitter arranged to communicate via an electrical connection with said thermometer to receive said signal and configured to transmit said signal,
a receiver frequency synced to said transmitter to receive said signal from said wireless transmitter,
a data storage unit comprising a flash memory with a UBS connector permitting a removable connection between said data storage unit and said receiver allowing said data storage unit to connect to said receiver to receive and store said signal.

19. The temperature sensing, signal transmitting and storage system according to claim 18, wherein at least one of said wireless transmitter and said receiver includes a display unit arranged to display an indicia indicative of the temperature read by said thermometer.

20. The temperature sensing, signal transmitting and storage system according to claim 19, wherein at least one of said transmitter and said receiver is battery powered.
